(19) United States
(12) Patent Application Publication
(10) Pub. No.: US 2015/0296969 A1
(43) Pub. Date: Oct. 22, 2015

(54) SEALANT APPLYING BRUSH AND SEALANT APPLYING METHOD

(71) Applicant: MITSUBISHI HEAVY INDUSTRIES, LTD., Tokyo (JP)

(72) Inventors: Nobuto Sakasegawa, Tokyo (JP); Koichi Nakamura, Tokyo (JP)

(73) Assignee: MITSUBISHI HEAVY INDUSTRIES, LTD., Tokyo (JP)

(21) Appl. No.: 14/439,656

(22) PCT Filed: Oct. 28, 2013
(86) PCT No.: PCT/JP2013/079173

§ 371 Date: Apr. 29, 2015

(30) Foreign Application Priority Data
Nov. 2, 2012 (JP) 2012-242630

(51) Int. Cl. A46B 9/02; B05D 1/28; B05D 1/00; A46B 9/12; B05C 17/00

(52) U.S. Cl. CPC A46B 9/02; A46B 9/12; B05C 17/00; B05D 1/002; B05D 1/28

(57) ABSTRACT

To facilitate to apply a base sealant around a prominence uniformly in a high quality is required for a composite material. A sealant applying brush includes a supporting section having a hole opened in a longitudinal direction and a ring shape on a plane orthogonal to the longitudinal direction; and a brush section having hairs implanted in a surface of the ring shape. By supplying such a brush with sealant, and eccentrically rotating the brush such that an inner circumference surface of the hole contacts the prominence of the surface of the workpiece, the sealant can be applied in a circular area around the prominence.

### TECHNICAL FIELD

The present invention relates to a technique of applying a sealant.

### BACKGROUND ART

In recent years, composite materials such as carbon-fiber-reinforced plastic (CFRP) and glass-fiber-reinforced plastic (GFRP) have been widely used. When such a composite material is used, a sealant material is applied to prevent a leakage of liquid in the composite materials and sparking from a step and a joint of the composite materials.

FIG. 1 is a sectional view showing an example of a sealant applied to a coupling portion of two sheets of composite materials. In this example, a first sheet member 101 is stacked on a second sheet member 102 and the first and second sheet members are fastened by a fastening member 103. Specifically, a fastener bolt is inserted from a side of the second member 102 into a through-hole which is formed to pass through the first member 101 and the second member 102, and the fastener nut 103-1 is fastened on a side of the first member 101. Thus, the first member 101 and the second member 102 are coupled and fastened.

In such a case, a gap and a prominence such as a circular column prominence and a hexagonal column prominence are formed in the surface of the composite material due to the fastening member 103 such as the bolt and the nut. Such a gap and a prominence are covered with a sealant from the viewpoint of preventing the leakage of liquid in the composite materials, the sparking, and so on.

In case that a prominence like the fastening member 103 of FIG. 1 exists on the surface, a base sealant 104 with a low viscosity is applied to the surface of the first member 101 around the fastening member 103. After the application of the base sealant 104, a fillet sealant 105 with a high viscosity is applied onto it. The adhesion of the fillet sealant 105 to the workpiece of the composite material is improved by applying the base sealant 104.

FIG. 2A and FIG. 2B are a top view and a side view showing a process of applying the base sealant 104 around the fastening member 103. The worker uses an application brush 108 with a brush 110 attached to an end of a handle 109 to apply the base sealant 104 to a workpiece surface by pushing and moving the brush 110 to the application area of the composite material as the workpiece.

Regarding the sealant for CFRP, an example is described in Patent Literature 1.

### CITATION LIST

[Patent literature 1] JP 2009-227166A

### SUMMARY OF THE INVENTION

The inventors of the present invention noticed a caution of the quality control in case of application of the base sealant 104. First, it is required that the width of the application area is constant. Second, the adhesion of the base sealant is required.

Regarding the first point, the application area of the base sealant 104 will be described with reference to FIG. 1. First, in case of design, the width of the area on which a fillet sealant 105 should be applied around the prominence (the fastening member 103) is prescribed. In FIG. 1, the fillet sealant 105 is applied in a circular ring area with a radius L102 around a central line 106 of the prominence, i.e. in the area of a circle with a width L101 from the prominence (fastener nut 103-1). The base sealant 104 is applied to the circular ring area with a radius L103 around the central line 106.

It is required that the base sealant 104 sufficiently covers the area in which the fillet sealant 105 is to be applied. Therefore, the radius L103 of the application area of the base sealant 104 is set larger than the radius L101 of the application area of the fillet sealant 105. Moreover, it is not desirable that the application area is too large. Therefore, it is desirable that the width of the circular ring application area of the base sealant 104 (or, a radius from the central line 106 of the fastening member 103 in FIG. 1) falls within in a predetermined range. However, it is difficult to apply the base sealant 104 in the circular ring area to be visually uniform and to have a constant width, because the worker applies the base sealant 104 by hand work by using application brush 108.

Next, regarding the second point, when the worker applies the base sealant 104 by using the application brush 108, there are the following two requests to improve the adhesion. First, it is desirable to carry out the application in a state that the hairs of brush 110 are kept upright in some degree. To improve the adhesion of the base sealant 104 to the composite material, it is required that the base sealant 104 is not only arranged on the material surface but also the base sealant 104 is applied to be rubbed into the material. However, there is a case that the hairs of the brush 110 becomes laid to the material surface, as shown in FIG. 3. In such a case, the adhesion of the base sealant 104 decreases. Second, the base sealant 104 is rubbed to an optional point of the applied area from the two or more directions. To apply to satisfy these two requests and the constant width of the application area is not easy at the conventional brush.

The technique of facilitating to apply the base sealant around the prominence and so on uniformly in a high quality is required for the composite material.

In an aspect of the present invention, a sealant applying brush has: a supporting section having a hole opened in a longitudinal direction and a ring shape on a plane orthogonal to the longitudinal direction; and a brush section having hairs implanted in a surface of the ring shape.

In another aspect of the present invention, the hole passes through the supporting section in the longitudinal direction.

In another aspect of the present invention, the supporting section has a bottom to close the hole.

In another aspect of the present invention, the supporting section has a surface of the hole as an inner circumferential surface and has a circular cylindrical shape with a central axis in the longitudinal direction.

In one aspect of the present invention, the sealant applying method includes: pushing the sealant applying brush against a workpiece surface having a prominence on a surface such that the prominence is arranged inside the hole; and eccentrically rotating the sealant applying brush around the prominence in a condition that the prominence is brought into contact with the inner surface of the hole, to apply a sealant to the workpiece surface.

The technique of facilitating to apply the base sealant around the prominence and so on uniformly in a high quality is provided for the composite material.

### BRIEF DESCRIPTION OF THE DRAWINGS

The above object, the other objects, the effect and the features of the present invention could be made clearer from the description of the embodiments in conjunction with the attached drawings.

FIG. 1 is a sectional view showing an example of sealant applied to a coupling portion of two sheets of composite materials.

FIG. 2A is a plan view showing a process of applying a base sealant around a fastening member.

FIG. 2B is a side view showing a process of applying the base sealant around the fastening member.

FIG. 3 is a side view showing a process of applying the base sealant around the fastening member.

FIG. 4 is a perspective view showing a sealant applying brush 10.

FIG. 5 is a sectional view showing a process of sealant application.

FIG. 6 is a top view showing a process of the sealant application.

FIG. 7 is a side view showing a sealant applying brush 10a.

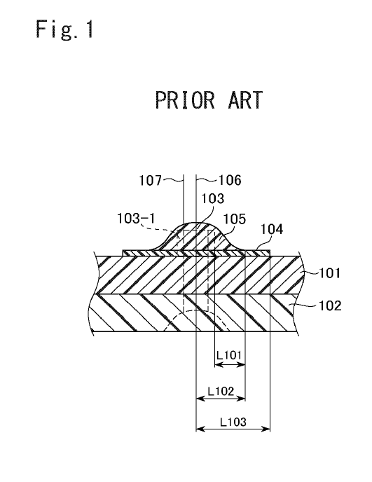

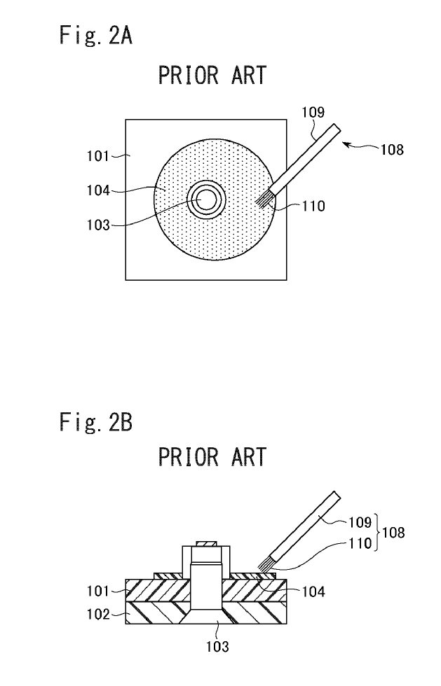

### DESCRIPTION OF EMBODIMENTS

Hereinafter, embodiments of the present invention will be described with reference to the attached drawings.

FIG. 4 is a perspective view showing a sealant applying brush 10 according to an embodiment. The sealant applying brush 10 is provided with a supporting section 11 which is a circular hollow cylindrical member having a rotation symmetrical shape around a central axis A. The supporting section 11 has an inner circumferential surface 14 of a radius R2 and an outer circumferential surface 15 of a radius R3 around the central axis A directed to a Z axis direction.

A brush section 12 is formed by implanting brush hairs in a negative direction of the Z axis of the supporting section 11, in a circular implantation surface 10-1 which is parallel to an xy plane xy plane surrounded by the inner circular surface with the radius R2 and the outer circular surface with the radius R3.

The structure of the brush section 12 will be described. The brush section 12 is provided with a plurality of hair bundles. The hair bundle is not furry and is hard. Therefore, for example, when the sealant applying brush 10 is put on the workpiece to direct a brush surface down, the hair bundle keeps an almost vertical attitude and only the ends of hair bundles contact the workpiece surface.

Each of the plurality of hair bundles is formed by bundling and implanting a plurality of hairs into the implantation surface 10-1 of the supporting section 11. Each of the plurality of hair bundles is arranged on a ring with a radius R1 (R2<R1<R3) from the central axis A. The plurality of hair bundles form a circular ring application surface with the radius R1 by being implanted at a constant interval in the circumferential direction on the implantation surface 10-1.

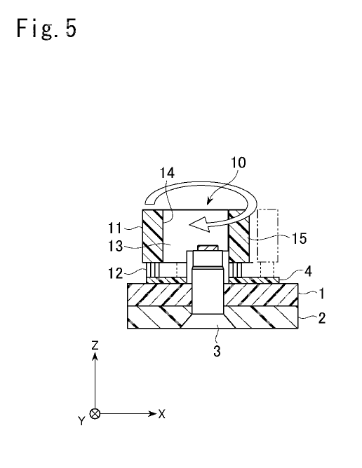

FIG. 5 is a sectional view showing a sealant applying method using such a sealant applying brush 10. The workpiece is shown in which a first member 1 and a second member 2 which are composite materials are fastened with a fastening member 3 such as a fastener bolt. One end of the fastening member 3 protrudes from the surface of the first member 1 and a base sealant 4 is applied around the prominence.

A worker supplies the base sealant 4 to the brush section 12 by immersing the brush section 12 in a liquid tank in which the base sealant 4 is saved. The worker has the supporting section 11, turns the brush section 12 to the composite material as the workpiece, and places the ends of the hairs on the surface of the workpiece (first member 1). At this time, the sealant applying brush 10 is arranged for the prominence of the fastening member 3 to be positioned inside the hole 13 of the radius R2 of the sealant applying brush 10.

The worker sets the sealant applying brush 10 such that the inner circumferential surface 14 contacts the prominence of the fastening member 3 in the condition that the brush section 12 contacts the workpiece surface. The worker revolves the sealant applying brush 10 around the prominence by the hand in the condition of contacting the prominent while pushing the brush section 12 against the workpiece surface. As a result, the sealant applying brush 10 is eccentrically rotated so that the base sealant 4 can be applied on the surface of the first member 1 in a ring area of a predetermined constant width having the fastening member 3 as a center. After the base sealant 4 becomes a dry condition, the worker applies a fillet sealant in a predetermined range of the ring area on which the base sealant 4 has been applied.

Because the ring area with the constant width can be applied in a short time through the eccentric movement, the applying work is sped up, compared with a case of using a pen-type brush. Moreover, because the coating width is constant, it is not unnecessary to check the application width.

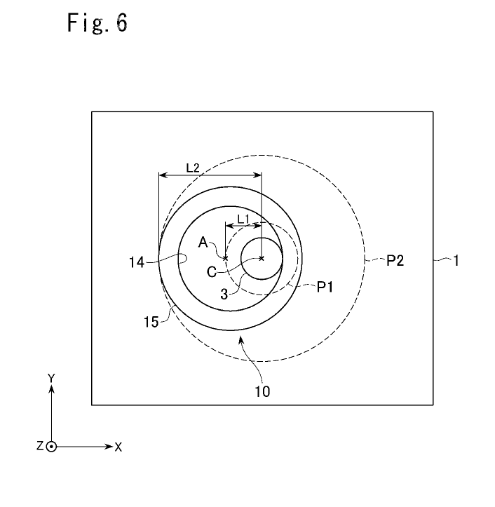

FIG. 6 is a top view showing the movement of the sealant applying brush 10 in detail. The fastening member 3 is shown as the prominence. In FIG. 6, the fastening member 3 has a column shape but may have another shape such as a hexagonal column shape. The worker carries out the application for the inner circumferential surface 14 to contact the outer circumference of the fastening member 3. Specifically, the worker can easily maintain the contact condition when holding the sealant applying brush 10 while applying a force to an eccentric direction in which the central axis A of the sealant applying brush 10 having the circular cylindrical shape leaves from the central point C of the fastening member 3.

When revolving the sealant applying brush 10 around the central point C of the fastening member 3 in the contact condition, the central axis A of the sealant applying brush 10 moves on a circular orbit P1 with a radius L1 around the central point C. That is, the sealant applying brush 10 having a plane shape like a circular ring around the central axis A carries out the eccentric movement around the central point C. As a result, the point which is the farthest from the point C on the outer circumferential surface 15 of the sealant applying brush 10 moves on a circular orbit P2 with a radius L2 (=L1+R3) around the point C.

Through the above movement, the brush section 12 carries out the movement to cover a circular ring area on the side of the outer circumference of the fastening member 3 and on the side of the inner circumference of the orbit P2. As a result, the base sealant 4 can be applied on the circular ring area inside the circle with a constant radius L2. Because the worker is sufficient to revolve the sealant applying brush 10 while applying a force directing to the outside from the point C, the base sealant 4 can be applied uniformly at high speed.

When the neighborhood of the prominence base is left as a non-applied area, a part of the brush section 12 in the circumferential direction is pushed to the prominence base while inclining a plane of the hair ends of the sealant applying brush 10 to the workpiece surface. By this operation, it is possible to bring the inclined hair ends into contact with the neighborhood of the prominence base.

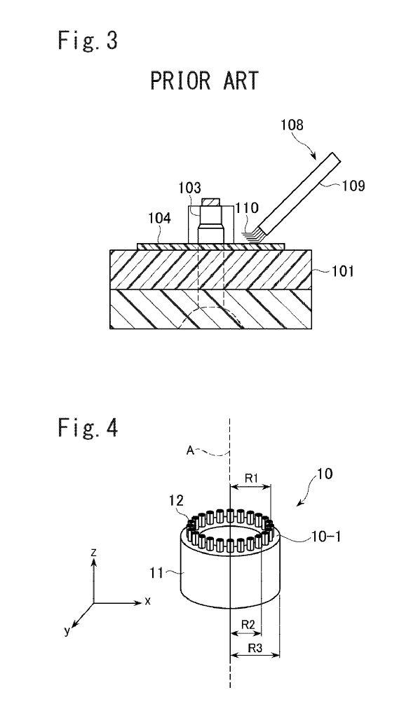

Because it is easy to keep the inclined state by a small angle to the workpiece surface, compared with a pen-type application brush, the sealant applying brush 10 can avoid the condition that the hair ends becomes laid as shown in FIG. 3. As a result, it is easy to apply the whole application surface of the workpiece in an even pressure and the adhesion of the base sealant 4 is improved. Moreover, because the hair ends of the brush carry out the eccentric movement with the eccentric movement of the sealant applying brush 10, the base sealant 4 can be applied from various directions to an optional point in the applied area. Therefore, it is easy to ensure the adhesion of the base sealant 4 to the workpiece surface.

During the application, the contact of the sealant applying brush 10 to the fastening member 3 (prominence) may be a rolling contact and a sliding contact. However, considering that the worker moves the sealant applying brush 10 in the condition holding the supporting section 11 with the hand, it is easy to make the sealant applying brush 10 revolve around the prominence without making the sealant applying brush 10 rotate, because there is a limitation in a movable range of the wrist. In this case, the eccentric movement is carried out while supporting the sealant applying brush 10 in the sliding contact to the fastening member 3.

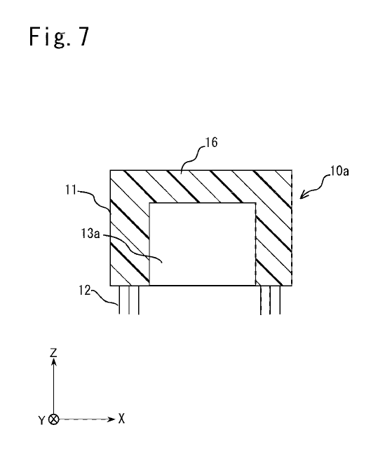

The hole 13 of the supporting section 11 passes through the supporting section 11 in the Z axis direction in an example of FIG. 5. However, when the prominence of the fastening member 3 is low, it is enough for the hole 13 to be opened in the direction of the workpiece and it is not necessary to pass through the supporting section 11. FIG. 7 shows an example of the sealant applying brush 10a which has such a non-passing-through hole 13a (a blind hole). In this example, a bottom 16 is formed on a side of the hole 13 opposite to the workpiece. When the prominence on the workpiece surface is small, such a structure may be adopted. However, when the hole 13 passes through the supporting section 11 as shown in FIG. 5, the base sealant 4 can be applied around the prominence on the workpiece surface if the height of the prominence is smaller than the diameter of the passing-through hole, even though the height of the prominence is higher than the thickness of the sealant applying brush 10.

In the above description, the sectional shape of the inner circumferential surface 14 by a plane orthogonal to a longitudinal direction of the supporting section is circular. However, the sectional shape of the inner circumference surface 14 may have a ring shape other than the circular shape. For example, the sectional shape of the inner circumferential surface 14 may have an elliptical shape, and a polygonal shape such as a hexagonal shape and an octagonal shape. Even if the sectional shape of the inner circumferential surface 14 has such a shape, the base sealant 4 can be applied to the circular area around the prominence. However, it is desirable from the viewpoint of the easy application that the sectional shape of the inner circumferential surface 14 has the circular shape.

Also, in the above description, the sectional shape of the outer circumferential surface 15 by the plane orthogonal to the longitudinal direction of the supporting section is circular. However, the sectional shape of the outer circumferential surface 15 may have a shape other than the circular shape. For example, the base sealant 4 can be applied to a circular area even if the sectional shape of the inner circumference surface 14 has the circular shape and the sectional shape of the outer circumferential surface 15 has a square shape. In this case, the hairs of the brush section 12 may be implanted to cover an almost whole part of the implantation surface 10-1 and may be implanted in a circular ring along the inner circumference. However, when the worker wants to see the workpiece surface as widely as possible without being hindered by the sealant applying brush 10, it is desirable that the outer circumferential surface 15 is along the inner circumferential surface (the supporting section 11 has a narrow ring shape), as in a case that both the sectional shapes of the outer circumferential surface 15 and the inner circumferential surface 14 are circular.

Note that this application is based on Japanese patent application JP 2012-242630 and claims a priority based on it. The disclosure thereof is incorporated herein by reference.

1. A sealant applying brush comprising:
a supporting section having a hole opened in a longitudinal direction and a ring shape on a plane orthogonal to the longitudinal direction; and
a brush section having hairs implanted in a surface of the ring shape.

2. The sealant applying brush according to the claim 1, wherein the hole passes through the supporting section in the longitudinal direction.

3. The sealant applying brush according to claim 1, wherein the supporting section has a bottom to close the hole.

4. The sealant applying brush according to claim 1 wherein the supporting section has a surface of the hole as an inner circumferential surface and has a circular cylindrical shape with a central axis in the longitudinal direction.

5. A sealant applying method using a sealant applying brush which comprises:
a supporting section having a hole opened in a longitudinal direction and a ring shape on a plane orthogonal to the longitudinal direction; and
a brush section having hairs implanted in a surface of the ring shape,
wherein the sealant applying method comprises:
pushing the sealant applying brush against a workpiece surface having a prominence on a surface such that the prominence is arranged inside the hole; and
eccentrically rotating the sealant applying brush around the prominence in a condition that the prominence is brought into contact with the inner surface of the hole, to apply a sealant to the workpiece surface.
